(19) United States
(12) Patent Application Publication
(10) Pub. No.: US 2026/0271052 A1
(43) Pub. Date: Sep. 10, 2026

(54) APPARATUSES AND WIRELESS COMMUNICATION METHODS FOR TXOP SHARING

(71) Applicant: SHENZHEN TCL NEW TECHNOLOGY CO., LTD., Shenzhen, Guangdong (CN)

(72) Inventor: Pei ZHOU, Shenzhen, Guangdong (CN)

(73) Assignee: SHENZHEN TCL NEW TECHNOLOGY CO., LTD., Shenzhen, Guangdong (CN)

(21) Appl. No.: 19/491,361

(22) PCT Filed: Jul. 18, 2023
(86) PCT No.: PCT/CN2023/108000

§ 371 Date: Dec. 8, 2025

(51) Int. Cl. H04W 74/00; H04W 72/30

(52) U.S. Cl. CPC H04W 74/002; H04W 72/30

(57) ABSTRACT

Apparatuses and wireless communication methods for transmit opportunity (TXOP) sharing are disclosed. A wireless communication method includes sending, by a first communication device, a frame to a second communication device to indicate a transmit opportunity (TXOP) sharing, wherein the frame includes a Contention-Free-End (CF-End) frame or a first frame. Another wireless communication method includes receiving, by a second communication device, a frame from a first communication device to indicate a TXOP sharing, wherein the frame comprises a CF-End frame or a first frame.

### TECHNICAL FIELD

The present disclosure relates to the field of wireless communication systems, and more particularly, to apparatuses and wireless communication methods for transmit opportunity (TXOP) sharing.

### BACKGROUND

Wireless communication systems are widely deployed to provide various types of communication content such as voice, video, packet data, messaging, broadcast, and so on. The wireless communication systems may be multiple-access systems capable of supporting communication with multiple users by sharing available system resources (such as, time, frequency, and power, etc.). A wireless network, for example a wireless local area network (WLAN), such as a Wi-Fi (institute of electrical and electronics engineers (IEEE) 802.11) network may include an access point (AP) that may communicate with one or more stations (STAs) or mobile devices.

Transmit opportunity (TXOP) sharing technique is recently defined by IEEE 802.11be standard. In details, in Triggered TXOP Sharing procedure of the IEEE 802.11be, this mechanism allows an access point (AP) to share the TXOP with a station (STA) but does not support the STA to share the TXOP with the AP. In a current IEEE document, non-AP initiated TXOP sharing proposes a method for a STA to share a TXOP for an AP. US20220053560A1 is a related prior art for this field. More particularly, US20220053560A1 also discloses a method for a STA to share a TXOP for an AP. However, the above method for the STA to share the TXOP for the AP is not fully considered. There are still many issues to be solved in the method for the STA to share the TXOP for the AP. It should be noted that, the STA refers to a non-AP STA.

Therefore, there is a need to further study apparatuses and wireless communication methods for TXOP sharing, which allows a STA to share a TXOP with an AP and/or at least one peer STA.

### SUMMARY

An object of the present disclosure is to propose apparatuses and wireless communication methods for TXOP sharing, which allows a STA to share a TXOP with an AP and/or at least one peer STA. It should be noted that, the STA refers to the non-AP STA.

In a first aspect of the present disclosure, a wireless communication method includes sending, by a first communication device, a frame to a second communication device to indicate a transmit opportunity (TXOP) sharing, wherein the frame includes a Contention-Free-End (CF-End) frame or a first frame.

In some embodiments, the first communication device includes a station (STA), and/or the second communication device includes an access point (AP) and/or at least one peer STA.

In some embodiments, the first frame includes a Transmit Opportunity (TXOP) Sharing frame.

In some embodiments, sending, by the first communication device, the CF-End frame to the second communication device to indicate the TXOP sharing is through a unicast communication or a groupcast communication.

In some embodiments, in the unicast communication, a Receiver Address (RA) field of the CF-End frame is set to a unicast address which is negotiated with the second communication device to indicate the TXOP sharing.

In some embodiments, in the groupcast communication, an RA field of the CF-End frame is set to a groupcast address which is negotiated with the second communication device to indicate the TXOP sharing.

In some embodiments, a Duration field of the CF-End frame indicates a part time of the TXOP sharing to the second communication device.

In some embodiments, if the Duration field of the CF-End frame is set to a first value, the Duration field of the CF-End frame indicates all the remaining time of the TXOP sharing to the second communication device.

In some embodiments, if the Duration field of the CF-End frame is set to a second value, the Duration field of the CF-End frame indicates a time length of the TXOP sharing to the second communication device.

In some embodiments, the first value of the Duration field of the CF-End frame is equal to 0, and/or the second value of the Duration field of the CF-End frame is different from 0.

In some embodiments, in the TXOP sharing, the CF-End frame indicates a partial bandwidth sharing of the first communication device to the second communication device through a non-high-throughput (non-HT) duplicate transmission.

In some embodiments, sending, by the first communication device, the first frame to the second communication device to indicate the TXOP sharing is a unicast communication, a groupcast communication, or a broadcast communication.

In some embodiments, an RA field of the first frame is set to a unicast address, a groupcast address, or a broadcast address which is negotiated with the second communication device to indicate the TXOP sharing.

In some embodiments, a first field of the first frame indicates a part time of the TXOP sharing to the second communication device.

In some embodiments, the first field of the first frame includes a Duration Allocation field.

In some embodiments, in the TXOP sharing, a second field of the first frame indicates a partial bandwidth sharing of the first communication device to the second communication device.

In some embodiments, the second field of the first frame includes a Resource Unit (RU) Allocation field.

In some embodiments, in the TXOP sharing, a partial bandwidth sharing of the first communication device is used by the second communication device; or in the TXOP sharing, the partial bandwidth sharing of the first communication device and an idle channel detected by the second communication device through a clear channel assessment (CCA) are used by the second communication device.

In some embodiments, a duration of idle channel detected by the second communication device through the CCA is greater than or equal to a duration of a priority interframe space (PIFS), a duration of a short interface space (SIFS), or a duration of a distributed coordination function (DCF) interframe space (DIFS).

In some embodiments, the wireless communication method further includes determining, by the first communication device, a remaining TXOP from the second communication device.

In some embodiments, a third field of the first frame indicates whether to return the remaining TXOP from the second communication device.

In some embodiments, the third field of the first frame includes a TXOP Sharing Mode field.

In some embodiments, if a duration of an idle channel detected through a CCA is greater than or equal to a duration of a PIFS, a duration of a SIFS, a duration of a DIFS, or an indicated duration by a fourth field of the first frame, the remaining TXOP is returned from the second communication device to the first communication device.

In some embodiments, the fourth field of the first frame includes a TXOP Return Duration field.

In some embodiments, the wireless communication method further includes receiving, by the first communication device, another CF-End frame from the second communication device, wherein the another CF-End frame indicates the remaining TXOP is returned from the second communication device; or receiving, by the first communication device, a Multi-User Request-To-Send (MU-RTS) Transmission Opportunity (TXOP) Sharing (TXS) Trigger frame from the AP, wherein the MU-RTS TXS Trigger frame indicates the remaining TXOP is returned from the AP.

In a second aspect of the present disclosure, a wireless communication method includes receiving, by a second communication device, a frame from a first communication device to indicate a transmit opportunity (TXOP) sharing, wherein the frame includes a Contention-Free-End (CF-End) frame or a first frame.

In some embodiments, the first communication device includes a station (STA), and/or the second communication device includes an access point (AP) and/or at least one peer STA.

In some embodiments, the first frame includes a Transmit Opportunity (TXOP) Sharing frame.

In some embodiments, receiving, by the second communication device, the CF-End frame from the first communication device to indicate the TXOP sharing is through a unicast communication or a groupcast communication.

In some embodiments, in the unicast communication, a Receiver Address (RA) field of the CF-End frame is set to a unicast address which is negotiated with the second communication device to indicate the TXOP sharing.

In some embodiments, in the groupcast communication, an RA field of the CF-End frame is set to a groupcast address which is negotiated with the second communication device to indicate the TXOP sharing.

In some embodiments, a Duration field of the CF-End frame indicates a part time of the TXOP sharing to the second communication device.

In some embodiments, if the Duration field of the CF-End frame is set to a first value, the Duration field of the CF-End frame indicates all the remaining time of the TXOP sharing to the second communication device.

In some embodiments, if the Duration field of the CF-End frame is set to a second value, the Duration field of the CF-End frame indicates a time length of the TXOP sharing to the second communication device.

In some embodiments, the first value of the Duration field of the CF-End frame is equal to 0, and/or the second value of the Duration field of the CF-End frame is different from 0.

In some embodiments, in the TXOP sharing, the CF-End frame indicates a partial bandwidth sharing of the first communication device to the second communication device through a non-high-throughput (non-HT) duplicate transmission.

In some embodiments, receiving, by the second communication device, the first frame from the first communication device to indicate the TXOP sharing is a unicast communication, a groupcast communication, or a broadcast communication.

In some embodiments, an RA field of the first frame is set to a unicast address, a groupcast address, or a broadcast address which is negotiated with the second communication device to indicate the TXOP sharing.

In some embodiments, a first field of the first frame indicates a part time of the TXOP sharing to the second communication device.

In some embodiments, the first field of the first frame includes a Duration Allocation field.

In some embodiments, in the TXOP sharing, a second field of the first frame indicates a partial bandwidth sharing of the first communication device to the second communication device.

In some embodiments, the second field of the first frame includes a Resource Unit (RU) Allocation field.

In some embodiments, in the TXOP sharing, a partial bandwidth sharing of the first communication device is used by the second communication device; or in the TXOP sharing, the partial bandwidth sharing of the first communication device and an idle channel detected by the second communication device through a clear channel assessment (CCA) are used by the second communication device.

In some embodiments, a duration of idle channel detected by the second communication device through the CCA is greater than or equal to a duration of a priority interframe space (PIFS), a duration of a short interface space (SIFS), or a duration of a distributed coordination function (DCF) interframe space (DIFS).

In some embodiments, the wireless communication method further includes determining, by the second communication device, a remaining TXOP of the second communication device.

In some embodiments, a third field of the first frame indicates whether to return the remaining TXOP from the second communication device.

In some embodiments, the third field of the first frame includes a TXOP Sharing Mode field.

In some embodiments, if a duration of an idle channel detected through a CCA is greater than or equal to a duration of a PIFS, a duration of a SIFS, a duration of a DIFS, or an indicated duration by a fourth field of the first frame, the remaining TXOP is returned from the second communication device to the first communication device.

In some embodiments, the fourth field of the first frame includes a TXOP Return Duration Field.

In some embodiments, the wireless communication method further includes sending, by the second communication device, another CF-End frame to the first communication device, wherein the another CF-End frame indicates the remaining TXOP is returned from the second communication device; or sending, by the second communication device, a Multi-User Request-To-Send (MU-RTS) Transmission Opportunity (TXOP) Sharing (TXS) Trigger frame to the first communication device, wherein the second communication device includes the AP, and the MU-RTS TXS Trigger frame indicates the remaining TXOP is returned from the AP.

In a third aspect of the present disclosure, a first communication device includes a memory, a transceiver, and a processor coupled to the memory and the transceiver. The first communication device is configured to perform the above method in the first aspect.

In a fourth aspect of the present disclosure, a second communication device includes a memory, a transceiver, and a processor coupled to the memory and the transceiver. The second communication device is configured to perform the above method in the second aspect.

In a fifth aspect of the present disclosure, a non-transitory machine-readable storage medium has stored thereon instructions that, when executed by a computer, cause the computer to perform the above method in the first aspect and/or the second aspect.

In a sixth aspect of the present disclosure, a chip includes a processor, configured to call and run a computer program stored in a memory, to cause a device in which the chip is installed to execute the above method in the first aspect and/or the second aspect.

In a seventh aspect of the present disclosure, a computer readable storage medium, in which a computer program is stored, causes a computer to execute the above method in the first aspect and/or the second aspect.

In an eight aspect of the present disclosure, a computer program product includes a computer program, and the computer program causes a computer to execute the above method in the first aspect and/or the second aspect.

In a ninth aspect of the present disclosure, a computer program causes a computer to execute the above method in the first aspect and/or the second aspect.

### BRIEF DESCRIPTION OF THE DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating an example of a wireless communications system according to an embodiment of the present disclosure.

FIG. 2 is a block diagram of a first communication device and a second communication device of communication in a wireless communications system according to an embodiment of the present disclosure.

FIG. 3A is a flowchart illustrating a wireless communication method performed by a first communication device according to an embodiment of the present disclosure.

FIG. 3B is a flowchart illustrating a wireless communication method performed by a first communication device according to an embodiment of the present disclosure.

FIG. 4A is a flowchart illustrating a wireless communication method performed by a second communication device according to an embodiment of the present disclosure.

FIG. 4B is a flowchart illustrating a wireless communication method performed by a second communication device according to an embodiment of the present disclosure.

FIG. 5 is a schematic diagram illustrating an example for a first communication device to share a TXOP to a second communication device according to an embodiment of the present disclosure.

FIG. 6 is a schematic diagram illustrating an example of a CF-End frame structure according to an embodiment of the present disclosure.

FIG. 7 is a schematic diagram illustrating an example of a first frame structure according to an embodiment of the present disclosure.

FIG. 8 is a schematic diagram illustrating an example of a first communication device sharing a partial bandwidth through non-HT duplicate transmission according to an embodiment of the present disclosure.

FIG. 9 is a schematic diagram illustrating an example wherein a first communication device indicates a field of a first frame to return TXOP according to an embodiment of the present disclosure.

FIG. 10 is a schematic diagram illustrating an example of a second communication device returning TXOP according to an embodiment of the present disclosure.

FIG. 11 is a block diagram of a system for wireless communication according to an embodiment of the present disclosure.

### DETAILED DESCRIPTION

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

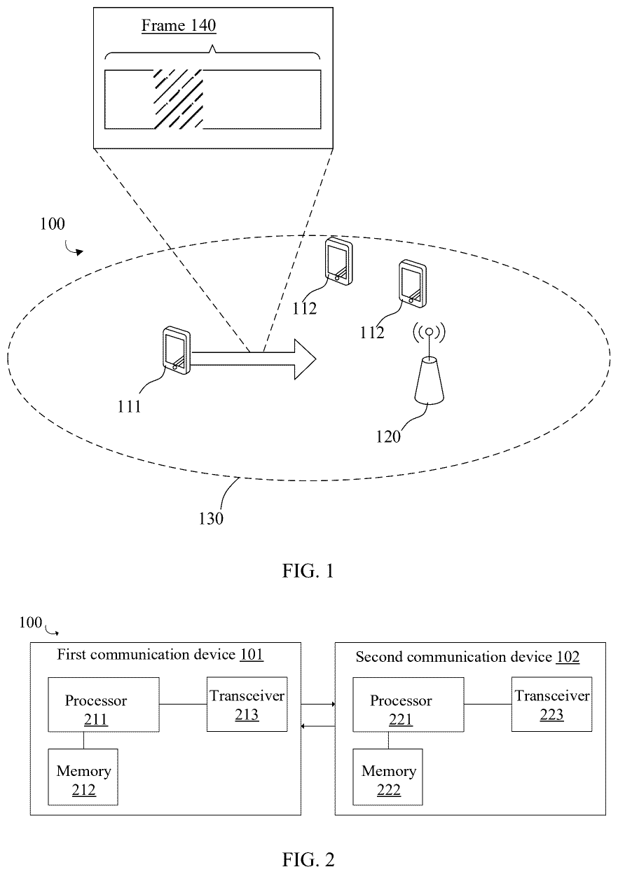

It should be noted that, in some embodiments of the present disclosure, a STA refers to a non-AP STA. FIG. 1 illustrates an example of a wireless communications system 100 according to an embodiment of the present disclosure. The wireless communications system 100 may include a first communication and a second communication. In some embodiments, the first communication device may include a station (STA) 111. The second communication device may include an access point (AP) 120 and/or at least one peer STA 112. The first communication device and the second communication device may be in a coverage area 130 of the wireless communications system 100. That is, the STA 111, at least one peer STA 112, and the AP 120 are in the coverage area 130. The first communication device is configured to send a frame 140 to the second communication device to indicate a transmit opportunity (TXOP) sharing. The frame may include a Contention-Free-End (CF-End) frame or a first frame. For example, the first frame may include a Transmit Opportunity (TXOP) Sharing frame.

In some embodiments, the second communication device is configured to receive a frame from the first communication device to indicate a transmit opportunity (TXOP) sharing. The frame may include a Contention-Free-End (CF-End) frame or a first frame. For example, the first frame may include a Transmit Opportunity (TXOP) Sharing frame.

In some examples, the STA 111 detects a channel through a clear channel assessment (CCA) and executes Enhanced Distributed Coordination Function (DCF) Channel Access (EDCA). After obtaining the TXOP at a certain time by the STA 111, the STA 111 can send at least one PPDU to the AP 120 and/or at least one peer STA 112 on a channel from the certain time. The channel may be a primary channel. The primary channel for example, is 80 MHz channel. If the STA 111 has no more traffic to transmit or no urgent/low-latency traffic to transmit on the obtained TXOP, the STA 111 can indicate the TXOP sharing to the AP 120 and/or at least one peer STA 112 by sending a CF-End frame or a first frame. The first frame may be a newly defined control frame such as TXOP Sharing frame. This mechanism allows the STA 111 to share the TXOP with the AP 120 and/or at least one peer STA 112 through the CF-End frame or the TXOP Sharing frame. The STA 111 may be a non-AP STA. The at least one peer STA 112 may be at least one non-AP STA.

In some alternative examples, the STA 111 may detect a channel through a CCA and may execute EDCA. Further, The STA 111 may detect TXOP time and bandwidth requirements of the AP 120 and/or at least one peer STA 112. In details, a duration of a first TXOP obtained by the STA 111 may be greater than a duration of time or other TXOP of the AP 120 and/or at least one peer STA 112 detected by the STA 111. For example, the duration of time or other TXOP of the AP 120 and/or at least one peer STA 112 detected by the STA 111 may be equal to a duration of a second TXOP. The duration of the second TXOP may be a duration of a part of the first TXOP obtained by the STA 111. Further, The STA 111 may share the duration of the second TXOP to the AP 120 and/or at least one peer STA 112.

FIG. 2 illustrates a first communication device and a second communication device of communication in a wireless communications system 100 according to an embodiment of the present disclosure. FIG. 2 illustrates that, the wireless communications system 100 includes a first communication device 101 and a second communication device 102. In some embodiments, the first communication device 101 may include a station (STA) 111 as illustrated in FIG. 1. The second communication device 102 may include an access point (AP) 120 and/or at least one peer STA 112 as illustrated in FIG. 1. The first communication device 101 may include a memory 212, a transceiver 213, and a processor 211 coupled to the memory 212 and the transceiver 213. The second communication device 101 may include a memory 222, a transceiver 223, and a processor 221 coupled to the memory 222, the transceiver 223. The processor 211 or 221 may be configured to implement proposed functions, procedures and/or methods described in this description. Layers of radio interface protocol may be implemented in the processor 211 or 221. The memory 212 or 222 is operatively coupled with the processor 211 or 221 and stores a variety of information to operate the processor 211 or 221. The transceiver 213 or 223 is operatively coupled with the processor 211 or 221, and the transceiver 213 or 223 transmits and/or receives a radio signal.

The processor 211 or 221 may include application-specific integrated circuit (ASIC), other chipset, logic circuit and/or data processing device. The memory 212 or 222 may include read-only memory (ROM), random access memory (RAM), flash memory, memory card, storage medium and/or other storage device. The transceiver 213 or 223 may include baseband circuitry to process radio frequency signals. When the embodiments are implemented in software, the techniques described herein can be implemented with modules (e.g., procedures, functions, and so on) that perform the functions described herein. The modules can be stored in the memory 212 or 222 and executed by the processor 211 or 221. The memory 212 or 222 can be implemented within the processor 211 or 221 or external to the processor 211 or 221 in which case those can be communicatively coupled to the processor 211 or 221 via various means as is known in the art.

In some embodiments, the transceiver 213 of the first communication device 101 is configured to send a frame 140 (as illustrated in FIG. 1) to the second communication device 102 to indicate a transmit opportunity (TXOP) sharing. The frame may include a Contention-Free-End (CF-End) frame or a first frame. For example, the first frame may include a Transmit Opportunity (TXOP) Sharing frame. In some embodiments, the transceiver 223 of the second communication device 102 is configured to receive a frame from the first communication device 101 to indicate a transmit opportunity (TXOP) sharing. The frame may include a Contention-Free-End (CF-End) frame or a first frame. For example, the first frame may include a Transmit Opportunity (txop) Sharing Frame.

In some examples, the processor 211 of the first communication device 101 detects a channel through a clear channel assessment (CCA) and executes Enhanced Distributed Coordination Function (DCF) Channel Access (EDCA). After obtaining the TXOP at a certain time by the processor 211, the transceiver 213 can send at least one PPDU to the second communication device 102 on a channel from the certain time. The channel may be a primary channel. The primary channel for example, is 80 MHz channel. If the transceiver 213 has no more traffic to transmit or no urgent/low-latency traffic to transmit on the obtained TXOP, the processor 211 can indicate the TXOP sharing to the second communication device 102 by sending a CF-End frame or a first frame. The first frame may be a newly defined control frame such as TXOP Sharing frame. This mechanism allows the first communication device 101 to share the TXOP with the second communication device 102 through the CF-End frame or the TXOP Sharing frame.

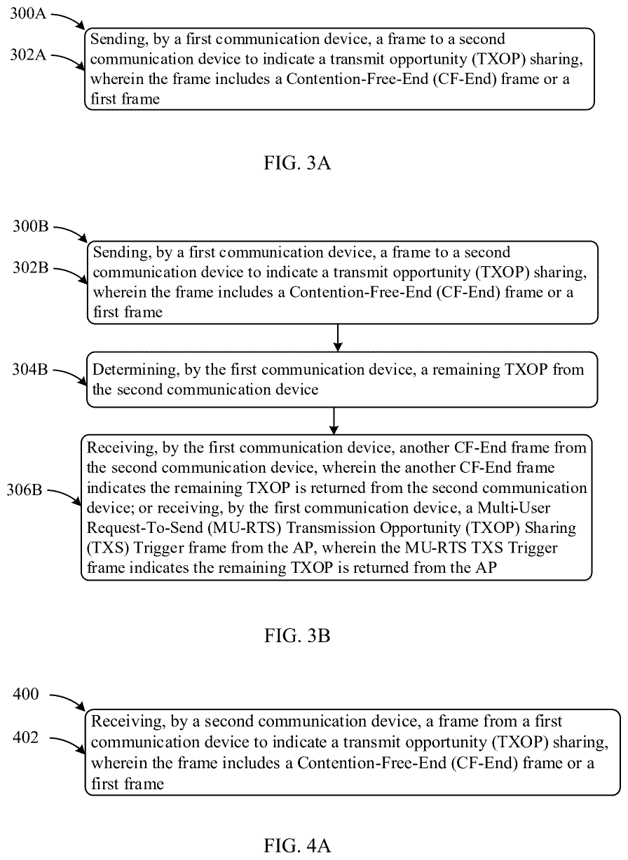

FIG. 3A illustrates a wireless communication method 300A performed by a first communication device according to an embodiment of the present disclosure. In some embodiments, the method 300A includes: an operation 302A, sending, by a first communication device, a frame to a second communication device to indicate a transmit opportunity (TXOP) sharing, wherein the frame includes a Contention-Free-End (CF-End) frame or a first frame.

In some embodiments, the first communication device includes a station (STA), and/or the second communication device includes an access point (AP) and/or at least one peer STA. FIG. 3B illustrates a wireless communication method 300B performed by a first communication device according to an embodiment of the present disclosure. In some embodiments, the method 300B includes: an operation 302B, sending, by a first communication device, a frame to a second communication device to indicate a transmit opportunity (TXOP) sharing, wherein the frame includes a Contention-Free-End (CF-End) frame or a first frame. Further, the method 300B may include an operation 304B, determining, by the first communication device, a remaining TXOP from the second communication device. Further, the method 300B may include an operation 306B, receiving, by the first communication device, another CF-End frame from the second communication device, wherein the another CF-End frame indicates the remaining TXOP is returned from the second communication device; or receiving, by the first communication device, a Multi-User Request-To-Send (MU-RTS) Transmission Opportunity (TXOP) Sharing (TXS) Trigger frame from the AP, wherein the MU-RTS TXS Trigger frame indicates the remaining TXOP is returned from the AP.

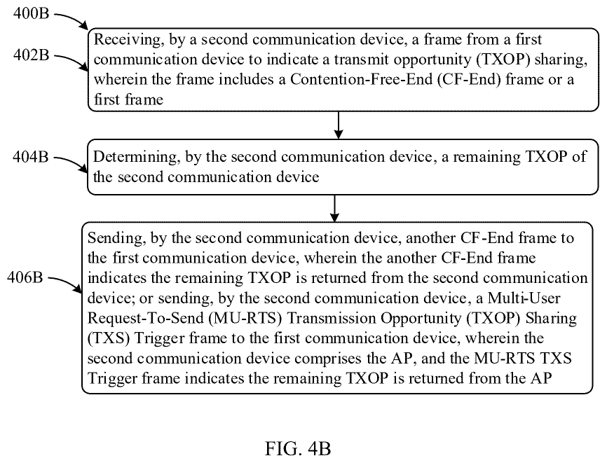

FIG. 4A illustrates a wireless communication method 400A performed by a second communication device according to an embodiment of the present disclosure. In some embodiments, the method 400 includes: an operation 402A, receiving, by a second communication device, a frame from a first communication device to indicate a transmit opportunity (TXOP) sharing, wherein the frame includes a Contention-Free-End (CF-End) frame or a first frame.

In some embodiments, the first communication device includes a station (STA), and/or the second communication device includes an access point (AP) and/or at least one peer STA. FIG. 4B illustrates a wireless communication method 400B performed by a second communication device according to an embodiment of the present disclosure. In some embodiments, the method 400B includes: an operation 402B, receiving, by a second communication device, a frame from a first communication device to indicate a transmit opportunity (TXOP) sharing, wherein the frame includes a Contention-Free-End (CF-End) frame or a first frame. Further, the method 400B may include an operation 404B, determining, by the second communication device, a remaining TXOP of the second communication device. Further, the method 400B may include an operation 406B, sending, by the second communication device, another CF-End frame to the first communication device, wherein the another CF-End frame indicates the remaining TXOP is returned from the second communication device; or sending, by the second communication device, a Multi-User Request-To-Send (MU-RTS) Transmission Opportunity (TXOP) Sharing (TXS) Trigger frame to the first communication device, wherein the second communication device comprises the AP, and the MU-RTS TXS Trigger frame indicates the remaining TXOP is returned from the AP.

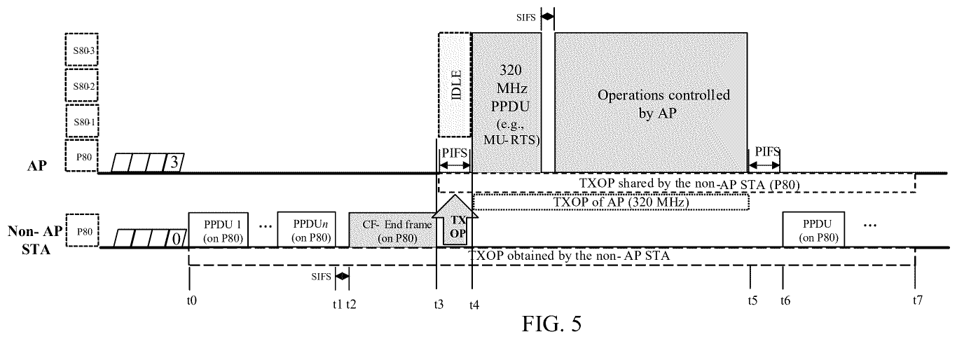

FIG. 5 illustrates an example for a first communication device to share a TXOP to a second communication device according to an embodiment of the present disclosure. In some embodiments, the first communication device may include a station (STA). The second communication device may include an access point (AP) and/or at least one peer STA. FIG. 5 illustrates that, in some embodiments, a STA obtains a TXOP. In details, the STA detects a channel through a clear channel assessment (CCA) and executes Enhanced Distributed Coordination Function (DCF) Channel Access (EDCA). The channel may be a primary channel. The primary channel is, for example, a 80 MHz channel shown in FIG. 5. After obtaining the TXOP at a certain time such as time t0 by the STA, the STA can send at least one PPDU (such as PPDU 1 to PPDU n) to the AP and/or at least one peer STA on the 80 MHz channel from the time t0. The time length of TXOP is for example from time t0 to time t7. For example, FIG. 5 illustrated that, in some examples, P80 may represent Primary 80 MHz, S80 may represent Secondary 80 MHz, and S80-x may represent secondary channel of the xth 80 MHz.

FIG. 5 illustrates that, in some embodiments, the STA can share the TXOP to the AP and/or at least one peer STA. In details, if the STA has no more traffic to transmit or no urgent/low-latency traffic to transmit on the obtained TXOP, the STA can indicate the TXOP sharing to the AP and/or at least one peer STA by sending a frame. The frame may include a CF-End frame or a newly defined control frame such as TXOP Sharing frame. FIG. 5 illustrates with the CF-End frame as an example. This mechanism allows the STA to share the TXOP with the AP and/or at least one peer STA through the CF-End frame or the TXOP sharing frame. The STA and/or at least one peer STA may be a non-AP STA. FIG. 5 illustrates with the non-AP STA as an example.

FIG. 5 illustrates that, in some embodiments, the STA may share a part or all of its operation bandwidth and/or TXOP time to the AP and/or at least one peer STA. In details, the STA may share all its operation bandwidth and/or TXOP time to the AP and/or at least one peer STA. The STA may also only share a part of the operation bandwidth and/or TXOP time with the AP and/or at least one peer STA and reserve another part of the operation bandwidth and/or TXOP time for itself to transmit other traffic. The another part of the operation bandwidth and/or TXOP time may be the remaining part of the operation bandwidth and/or TXOP time. This can be done by sending a CF-End frame or clearly indicating in the newly defined control frame such as a TXOP Sharing frame which channels and/or how long the STA has shared with the AP and/or at least one peer STA.

FIG. 5 illustrates that, in some embodiments, a partial bandwidth sharing of the STA or the partial bandwidth sharing of the STA and an idle channel are used by the AP or at least one peer STA. In details, the AP and/or at least one peer STA can directly use the remaining TXOP on the bandwidth that the STA is operation on (that is, time t3 or t4 to time t7 in FIG. 5). The AP and/or at least one peer STA may also be on a channel other than the one the STA is operating on (e.g., a 240 MHz channel other than the 80 MHz channel shown in FIG. 5). After CCA detects that the channel is idle and the channel idle time is equal to or greater than a certain duration (e.g., PIFS), the AP and/or at least one peer STA work together directly on the channel shared by the STA and/or the channel detected as idle by the CCA (i.e., the 320 MHz channel shown in FIG. 5).

Through some implementations of the present disclosure, the second communication device detects the duration of other channels (such as PIFS duration) through CCA, which can efficiently realize that the second communication device uses an additional channel for transmission. Through some implementations of the present disclosure, it can be realized that the first communication device may only share a part of the channel/bandwidth and/or a part of the TXOP time with the second communication device.

FIG. 5 illustrates that, in some embodiments, a TXOP return mechanism of returning the remaining TXOP sharing from the AP or at least one peer STA. In details, after the AP and/or at least one peer STA has finished its/their transmission(s), if there is the remaining TXOP (such as the TXOP at time t5 to t7 in FIG. 5), the STA can take the initiative to take back the shared TXOP through timeout (such as PIFS in FIG. 5). Alternatively, the AP or at least one peer STA explicitly send a termination usage frame to return the remaining TXOPs to the STA. It will be described in detail in some later embodiments. Through some implementations of the present disclosure, the second communication device can return the remaining TXOP to the first communication device.

In some embodiments, the first communication device is configured to send the CF-End frame to the second communication device to indicate the TXOP sharing is through a unicast communication or a groupcast communication. In some embodiments, in the unicast communication, a Receiver Address (RA) field of the CF-End frame is set to a unicast address which is negotiated with the second communication device to indicate the TXOP sharing. In some embodiments, in the groupcast communication, an RA field of the CF-End frame is set to a groupcast address which is negotiated with the second communication device to indicate the TXOP sharing.

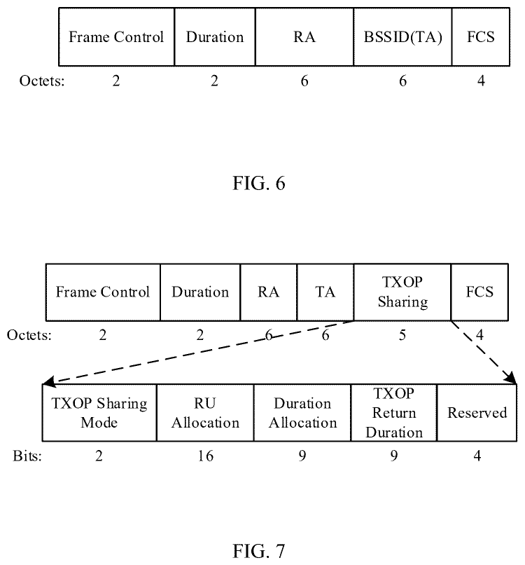

In details, FIG. 6 illustrates an example of a CF-End frame structure according to an embodiment of the present disclosure. FIG. 6 illustrates that, in some embodiments, a STA is configured to send a CF-End frame to an AP and/or at least one peer STA to indicate a TXOP sharing. FIG. 6 shows the CF-End frame structure, where a Receiver Address (RA) field represents a MAC address of a receiver, and Basic Service Set identifier (BSSID) (or TA) field represents a MAC address of a transmitter. In some embodiments, sending, by the STA, the frame to the AP or the at least one peer STA to indicate the TXOP sharing includes sending, by the STA, the CF-End frame to the AP or at least one peer STA to indicate the TXOP sharing through a unicast communication or a groupcast communication.

In some embodiments, in the unicast communication, a Receiver Address (RA) field of the CF-End frame is set to a unicast address which is negotiated with the AP or one of the at least one peer STA to indicate the TXOP sharing. In details, if a STA such as an ultra-high reliable (UHR) STA sends the CF-End frame by unicast communication (that is, the RA field of the frame is set to a MAC address of the AP and/or one of at least one peer STA), only the AP (and/or corresponding at least one peer STA) may receive the CF-End frame, the AP (and/or one of corresponding at least one peer STA) knows that the STA that sent the frame wants to share its TXOP. Other STA(s) is not the target recipient(s) of the CF-End frame, and may still determine that the current TXOP is being used by the STA. This enables the STA to share the TXOP to the AP (and/or a specific STA) for use. The specific STA may be at least one peer STA.

In some embodiments, in the groupcast communication, an RA field of the CF-End frame is set to a groupcast address which is negotiated with the AP or the at least one peer STA to indicate the TXOP sharing. The STA may be an ultra-high reliable (UHR) STA. In details, if the UHRSTA sends the CF-End frame by the groupcast communication, that is, the RA field of the frame is set to a groupcast address corresponding to the AP and/or some STAs, or set to the groupcast address corresponding to some STAs other than the AP, only some STAs corresponding to the AP and the groupcast address (or some STAs corresponding to the groupcast address) may receive the CF-End frame. Some STAs corresponding to the AP and the groupcast address (or some STAs corresponding to the groupcast address) know that the STA sending the frame may share its TXOP. Other STAs are not the target recipients of the CF-End frame, and may still determine that the current TXOP is being used by the original STA. This enables the STA to share the TXOP to the AP and some STAs corresponding to the groupcast address (or some STAs corresponding to the groupcast address) for use.

FIG. 7 illustrates an example of a first frame structure according to an embodiment of the present disclosure. The first frame may be a TXOP Sharing frame. FIG. 7 illustrates that, in some embodiments, a STA is configured to send a TXOP Sharing frame to an AP and/or at least one peer STA to indicate a TXOP sharing. In some embodiments, sending, by the first communication device, the first frame to the second communication device to indicate the TXOP sharing is a unicast communication, a groupcast communication, or a broadcast communication. In some examples, sending, by the STA, the frame to the AP or the at least one peer STA to indicate the TXOP sharing includes sending, by the STA, the TXOP sharing frame to the AP or the at least one peer STA to indicate the TXOP sharing through a unicast communication, a groupcast communication, or a broadcast communication. In some embodiments, an RA field of the TXOP sharing frame is set to a unicast address, a groupcast address, or a broadcast address which is negotiated with the AP and/or the at least one peer STA to indicate the TXOP sharing.

The STA may be an Ultra-High Reliable (UHR) STA. FIG. 7 illustrates that, in details, if UHR STA sends TXOP Sharing frame by unicast communication, that is, the RA field of the frame is set to the MAC address of the AP and/or other UHR STAS, only the AP (and/or other corresponding UHR STAs) may receive the TXOP Sharing frame, the AP (and/or other corresponding UHR STA) knows that the UHR STA that sent the frame wants to share its TXOP. Other UHR STAs are not the target recipients of the TXOP Sharing frame, and may still determine that the current TXOP is being used by the original UHR STA. This enables the UHR STA to share the TXOP to the AP (and/or a specific UHR STA) for use.

FIG. 7 illustrates that, in details, if UHR STA sends TXOP Sharing frame by the groupcast communication, that is, the RA field of the frame is set to the groupcast address corresponding to the AP and some UHR STAs, or to the groupcast address corresponding to some UHR STAs except the AP, only some UHR STAs and the AP corresponding to the groupcast address (or some UHR STAs corresponding to the groupcast address) may receive the TXOP Sharing frame, some UHR STAs and the AP corresponding to the groupcast address (or some UHR STAs corresponding to the groupcast address) know that the UHR STA that has sent the frame wants to share its TXOP. Other (UHR) STAs are not the target recipients of the TXOP Sharing frame and may still determine that the current TXOP is being used by the UHR STA. This enables the UHR STA to share the TXOP to the AP and some UHR STAs corresponding to the groupcast address (or some UHR STAs corresponding to the groupcast address) for use. It is understood that AP can be one of members of the groupcast address. For example, the groupcast address can correspond to the following scenarios: 1. A group of STAs. 2. One AP and a group of STAs.

If UHR STA sends TXOP Sharing frame by the broadcast communication, that is, the RA field of the frame is set to the broadcast address, all UHR STAs and APs in a basis service set (BSS) where the UHR STA is located may receive the TXOP Sharing frame, the AP and UHR STAs may determine that the UHR STA that sent the frame may share its TXOP to the AP. This realizes the UHR STA sharing the TXOP for the AP to use.

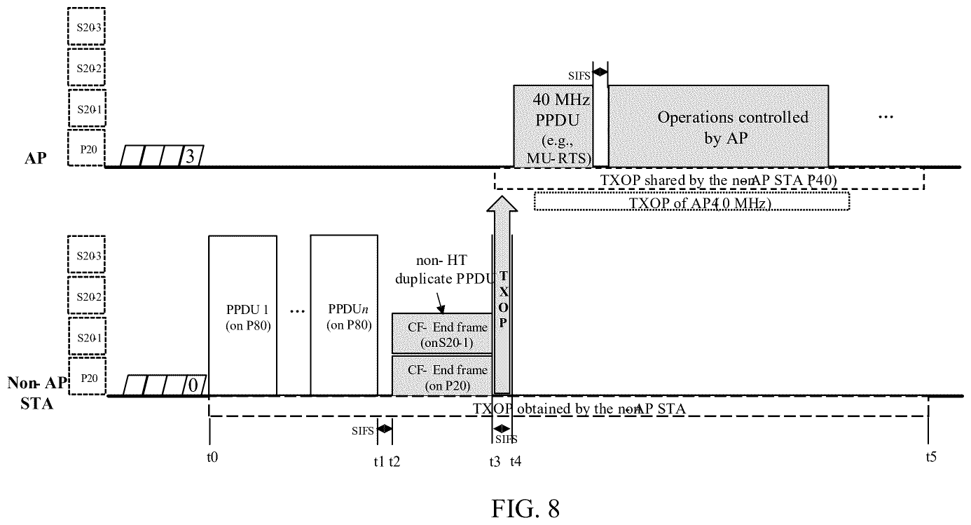

FIG. 8 illustrates that, in some embodiments, the STA indicates a part time of the TXOP sharing and/or a partial bandwidth to the AP or the at least one peer STA. In some examples, the UHR STA may only share part of its TXOP time and/or part of frequency resources of its operation bandwidth to the AP (and/or other UHR STAs). In this case, the UHR STA can still use the unshared TXOP time and/or part of the operation bandwidth to transmit other traffic.

FIG. 8 illustrates that, in some embodiments, if the UHR STA sends a CF-End frame to share the obtained TXOP, the method for the UHR STA to share part of the obtained TXOP is as follows. Some embodiments of the present invention propose to reuse/redefine a Duration field of the CF-End frame as an indication of the TXOP duration shared by the UHR STA. In some embodiments, the Duration field of the CF-End frame indicates a part time of the TXOP sharing to the second communication device (such as an AP and at least one peer STA). In some embodiments, if the Duration field of the CF-End frame is set to a first value, the Duration field of the CF-End frame indicates all the remaining time of the TXOP sharing to the second communication device. In some embodiments, if the Duration field of the CF-End frame is set to a second value, the Duration field of the CF-End frame indicates a time length of the TXOP sharing to the second communication device. In some embodiments, the first value of the Duration field of the CF-End frame is equal to 0, and/or the second value of the Duration field of the CF-End frame is different from 0.

In details, if the Duration field is equal to 0, the UHR STA shares all the remaining time of the obtained TXOP. If the Duration field is not equal to 0, then the Duration field is defined as the time length of the TXOP shared by the UHR STA, and the starting point is the end of the current CF-End frame transmission. This means that UHR STA may only share part of the obtained TXOP. The Duration field has a total of 2 bytes (i.e., 16 bits), which can represent 216 values, and the unit can be set to 16 microseconds (but not limited to 16 microseconds). The unit can be set to 8 microseconds, 4 microseconds, 2 microseconds, or 1 microsecond seconds, etc.). FIG. 8 illustrates that, in some embodiments, if the UHR STA sends a CF-End frame to share the obtained TXOP, the method for the UHR STA to share a part of the operation bandwidth is as follows. In some embodiments, in the TXOP sharing, the CF-End frame indicates a partial bandwidth sharing of the first communication device to the second communication device through a non-high-throughput (non-HT) duplicate transmission. In some examples, the UHR STA shares a partial bandwidth through non-HT duplicate transmission. In details, if the operation bandwidth of the UHR STA is greater than 20 MHz (such as 80 MHz in FIG. 8), the UHR STA may only share part of its operation bandwidth (for example, 40 MHz). The implementation method is that UHR STA adopts the method of non-HT duplicate transmission. The UHR STA may send non-HT duplicate PPDUs (including CF-End frame) on the bandwidth/channel to be shared by UHR STA (for example, the two 20 MHz channels P20 and S20-1 shown in FIG. 8). For the receiver (such as AP), it may only receive the CF-End frame sent by the UHR STA on part of the bandwidth/channel (i.e., the two 20 MHz channels P20 and S20-1). Therefore, the receiver determines that the UHR STA may only share the TXOP on the channel for its use and may not use other unshared bandwidth/channels (such as the two 20 MHz channels S20-2 and S20-3 shown in FIG. 8).

In some embodiments, a first field of the first frame indicates a part time of the TXOP sharing to the second communication device. The first field of the first frame may include a Duration Allocation field. Referring to FIG. 7, which illustrates that, in some embodiments, if the UHR STA sends a TXOP Sharing frame to share the obtained TXOP, the method for the UHR STA to share part of the obtained TXOP is as follows. As shown in FIG. 7, the TXOP Sharing frame is a newly defined frame in some embodiments of the present disclosure. The time length of the TXOP shared by the UHR STA can be indicated through a Duration Allocation field of the TXOP Sharing frame, and the starting point is the end of the current TXOP Sharing frame transmission. The Duration Allocation field may have a total of 9 bits, which can represent 29 values, and the unit can be set to 16 microseconds (but not limited to 16 microseconds). The unit can be set to 8 microseconds, 4 microseconds, 2 microseconds, or 1 microsecond seconds, etc.). In some embodiments, the Duration Allocation field may have a total of 10 bits, 8 bits, or other bits, The present invention is not limited thereto, and can be adjusted according to the needs of the design.

In some embodiments, in the TXOP sharing, a second field of the first frame indicates a partial bandwidth sharing of the first communication device to the second communication device. In some embodiments, the second field of the first frame includes a Resource Unit (RU) Allocation field. Referring to FIG. 7, which illustrates that, in some embodiments, if the UHR STA sends a TXOP Sharing frame to share the obtained TXOP, the method for the UHR STA to share a part of the operation bandwidth is as follows. In details, as shown in FIG. 7, the RU Allocation field of the TXOP Sharing frame can be used to indicate the operation bandwidth/channel shared by the UHR STA. The length of the RU Allocation field can be 16 bits. The RU Allocation field length can also be set to 8 bits like the RU Allocation field of the User Info field in the MU-RTS TXS Trigger frame in the 802.11be standard. If the length of the RU Allocation field of the TXOP Sharing frame is set to 8 bits, then its indication method and definition are the same as the RU Allocation field of the User Info field in the MU-RTS TXS Trigger frame in the 802.11be standard and will not be repeated here.

If the length of the RU Allocation field is set to 16 bits as shown in FIG. 7, there are two methods to indicate the shared operation bandwidth. The first method is to use the RU Allocation field of 16 bits. In the 16 bits, 8 bits are defined as the same indication method as the RU Allocation field of the User Info field in the MU-RTS TXS Trigger frame in the 802.11be standard, and the remaining 8 bits are set as reserved bits. The second method is that the 16 bits of the RU Allocation field correspond to each 20 MHz channel in the 320 MHz bandwidth one by one through the bitmap. If the corresponding bit is set to 1, it means that the UHR STA shares the 20 MHz channel. If the corresponding bit is set to 0, it means that the UHR STA does not share the 20 MHz channel, and the UHR STA uses it by itself.

In some embodiments, in the TXOP sharing, a partial bandwidth sharing of the first communication device is used by the second communication device; or in the TXOP sharing, the partial bandwidth sharing of the first communication device and an idle channel detected by the second communication device through a clear channel assessment (CCA) are used by the second communication device. In some examples, the AP may obtain a bandwidth other than the bandwidth shared by the STA to work. In details, as shown in FIG. 5, the UHR STA works on the primary 80 MHz (P80) channel. At time t2, the UHR STA sends a CF-End frame (or TXOP Sharing frame) to the AP on the primary 80 MHz channel. This means that the UHR STA shares the 80 MHz channel for the AP to use. If the AP wants to use a larger bandwidth (for example, 320 MHz in FIG. 5) to transmit within the TXOP shared by the UHR STA, it can be achieved through the following methods.

In some embodiments, a duration of idle channel detected by the second communication device through the CCA is greater than or equal to a duration of a priority interframe space (PIFS), a duration of a short interface space (SIFS), or a duration of a distributed coordination function (DCF) interframe space (DIFS). In some examples, the AP performs detection on other channels (another three 80 MHz sub-channels, such as S80-1, S80-2, and S80-3) through CCA. If other channels (such as S80-1, S80-2, and S80-3) are detected to be idle for a duration greater than or equal to a duration of a priority interframe space (PIFS), a duration of a short interface space (SIFS), or a duration of a distributed coordination function (DCF) interframe space (DIFS), the AP may determine that no other devices are using other channels (such as S80-1, S80-2, and S80-3). The AP can directly use the 80 MHz channel shared by the UHR STA to work with other channels detected as idle by the CCA (that is, the 240 MHz secondary channel in FIG. 5).

In some embodiments, the first communication device is configured to determine a remaining TXOP from the second communication device. In some embodiments, the second communication device is configured to determine the remaining TXOP of the second communication device. In some embodiments, a third field of the first frame indicates whether to return the remaining TXOP from the second communication device. In some embodiments, the third field of the first frame includes a TXOP Sharing Mode field.

In some examples, there are some methods for the AP to return the remaining TXOP to the STA. In some examples, the signaling indication design whether the AP needs to return the TXOP is an optional function. If the STA shares the TXOP through the TXOP Sharing frame, the UHR STA can clearly indicate whether the AP needs to return the remaining TXOP to the original UHR STA after using the shared TXOP in advance. As shown in FIG. 7, a TXOP Sharing Mode field of the TXOP Sharing frame is 2 bits, the following designation can be indicated.

In some embodiments, if a duration of an idle channel detected through a CCA is greater than or equal to a duration of a PIFS, a duration of a SIFS, a duration of a DIFS, or an indicated duration by a fourth field of the first frame, the remaining TXOP is returned from the second communication device to the first communication device. In some embodiments, the fourth field of the first frame includes a TXOP Return Duration Field.

It should be noted that 00 here is 00 in binary, 01 here is 01 in binary, 10 here is 10 in binary, and 11 here is 11 in binary. Specifically, the 10 here is 10 in binary (equivalent to two in decimal), not ten in decimal. In some examples, if the TXOP Sharing Mode field is equal to 00, the AP does not need to return to the original UHR STA after the TXOP is terminated in advance. The AP can directly release the TXOP for all STAs in the BSS to compete for use. The TXOP Return Duration field is set as a reserved bit.

In some examples, if the TXOP Sharing Mode field is equal to 01, the AP cannot release the TXOP after the AP ends the use of the TXOP in advance. The AP needs to use the implicit return method to return the remaining TXOP to the original UHR STA. The AP is used combine with TXOP Return Duration field.

In some examples, if the TXOP Sharing Mode field is equal to 10, the AP cannot release the TXOP after the AP ends the use of the TXOP in advance. The remaining TXOP can be returned to the original UHR STA by an explicit return method. The TXOP Return Duration field is set as a reserved bit.

In some examples, XOP Sharing Mode field equal to 11 is set as a reserved value.

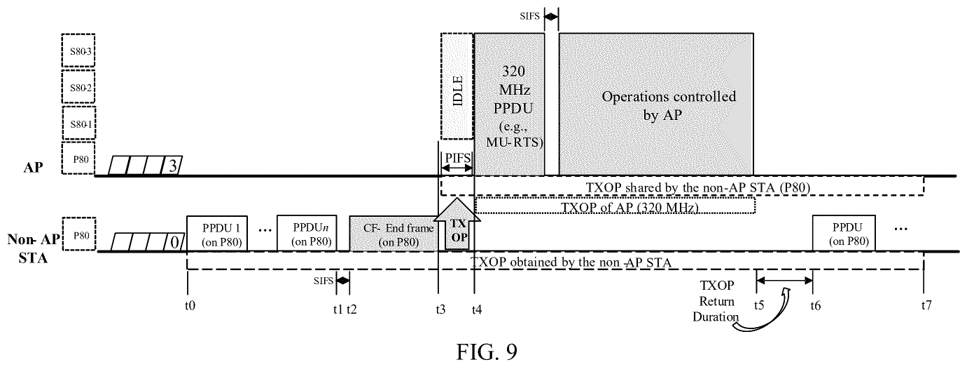

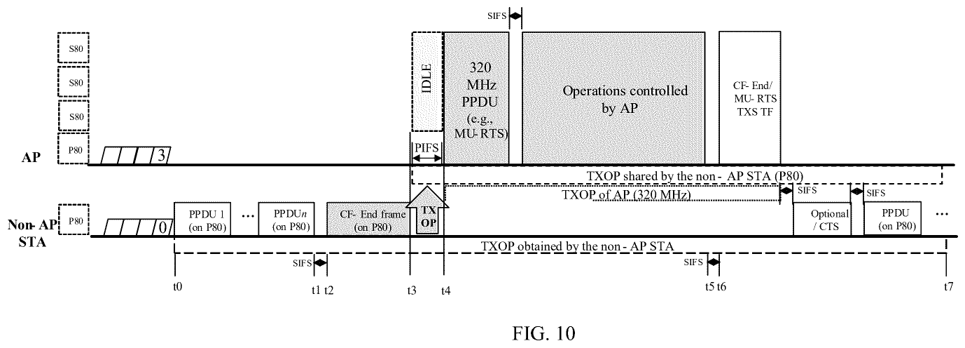

In some examples, if the AP needs to return the remaining TXOP (that is, TXOP Sharing Mode field equal to 01 or 10), there are several implement methods as follows. The implement method may include a method of AP implicitly returning TXOP as illustrated in FIG. 9 and/or a method of AP explicitly returning TXOP as illustrated in FIG. 10.

In some examples, the method of AP implicitly returning TXOP includes an automatic recovery of idle time and a configurable idle time. In details, in the automatic recovery of idle time, as shown in FIG. 5, after the AP finishes using the TXOP shared by the UHR STA, it may not send any frames by default. The UHR STA that shares the TXOP detects through CCA that the shared channel idle time is greater than or equal to PIFS, then immediately obtains the remaining TXOP, and continues to send the frame(s) as a TXOP holder.

In details, in the method of AP explicitly returning TXOP, as shown in FIG. 7 and FIG. 9, when the UHR STA shares its TXOP to the AP through the TXOP Sharing frame, the UHR STA informs the AP of the idle return time of the channel in the TXOP Return Duration field of the frame. After the AP finishes using the TXOP shared by the UHR STA, it may not send any frames by default. The UHR STA sharing the TXOP detects through CCA that the shared channel idle time is greater than or equal to the time indicated by the TXOP Return Duration field, and the UHR STA may immediately take back the right to use the channel and continue to send frames as a TXOP holder.

In some embodiments, the first communication device is configured to receive another CF-End frame from the second communication device, wherein the another CF-End frame indicates the remaining TXOP is returned from the second communication device. In some embodiments, the first communication device is configured to receive a Multi-User Request-To-Send (MU-RTS) Transmission Opportunity (TXOP) Sharing (TXS) Trigger frame from the AP, wherein the MU-RTS TXS Trigger frame indicates the remaining TXOP is returned from the AP.

In some examples, the method of AP explicitly returning TXOP may be performed through the CF-End frame or a MU-RTS TXS Trigger frame. In details, as shown in FIG. 10, after the AP finishes using the TXOP shared by the UHR STA, it initiatively sends a unicast CF-End frame to the original UHR STA to stop using the TXOP. After receiving the CF-End frame, the original UHR STA immediately reclaims the channel using right and continues to send frames as a TXOP holder. Understandably, after the AP finishes using the TXOP shared by the UHR STA, it can also initiatively send a broadcast CF-End frame that terminates the use of the TXOP. All STAs in the BSS where the AP is located can compete to use the TXOP released by the AP after receiving the CF-End frame.

In details, as shown in FIG. 10, after the AP finishes using the TXOP shared by the UHR STA, it uses the Triggered TXOP Sharing mechanism of 802.11be to actively send a MU-RTS TXS Trigger frame to share the remaining TXOP with the original UHR STA. Understandably, after the AP finishes using the TXOP shared by the UHR STA, it can use the Triggered TXOP Sharing mechanism of 802.11be to actively send the MU-RTS TXS Trigger frame to share the remaining TXOP with other STAs other than the original UHR STA.

Some embodiments of the present disclosure belong to one of the possible technologies of Wi-Fi 8 in the future. If adopted by the Wi-Fi 8 standard, then all devices adopting the Wi-Fi 8 standard in the future may use the invented technology.

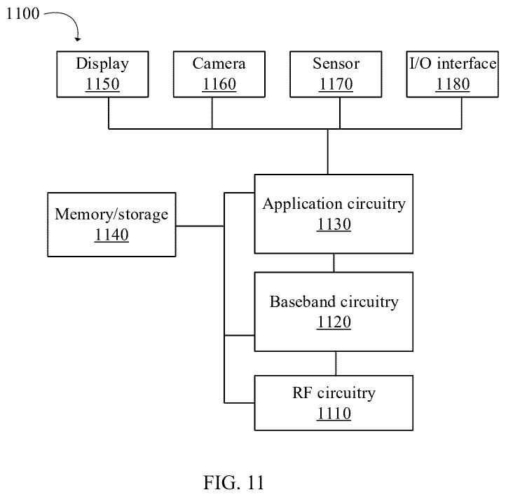

FIG. 11 is a block diagram of an example system 1100 for wireless communication according to an embodiment of the present disclosure. Embodiments described herein may be implemented into the system using any suitably configured hardware and/or software. FIG. 11 illustrates the system 1100 including a radio frequency (RF) circuitry 1110, a baseband circuitry 1120, an application circuitry 1130, a memory/storage 1140, a display 1150, a camera 1160, a sensor 1170, and an input/output (I/O) interface 1180, coupled with each other at least as illustrated. The application circuitry 1130 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. In various embodiments, the transmitter circuitry, control circuitry, or receiver circuitry discussed above with respect to the first communication device 101 and/or the second communication device 102 of FIG. 2 may be embodied in whole or in part in one or more of the RF circuitry, the baseband circuitry, and/or the application circuitry.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A wireless communication method, comprising:
sending, by a first communication device, a frame to a second communication device to indicate a transmit opportunity (TXOP) sharing, wherein the frame comprises a first frame.

2-11. (canceled)

12. The wireless communication method of claim 1, wherein sending, by the first communication device, the first frame to the second communication device to indicate the TXOP sharing is a unicast communication, a groupcast communication, or a broadcast communication.

13. (canceled)

14. The wireless communication method of claim 12, wherein a first field of the first frame indicates a part time of the TXOP sharing to the second communication device.

15. (canceled)

16. The wireless communication method of claim 12, wherein in the TXOP sharing, a second field of the first frame indicates a partial bandwidth sharing of the first communication device to the second communication device.

17. (canceled)

18. The wireless communication method of claim 1, wherein in the TXOP sharing, a partial bandwidth sharing of the first communication device is used by the second communication device; or in the TXOP sharing, the partial bandwidth sharing of the first communication device and an idle channel detected by the second communication device through a clear channel assessment (CCA) are used by the second communication device.

19. The wireless communication method of claim 18, wherein a duration of idle channel detected by the second communication device through the CCA is greater than or equal to a duration of a priority interframe space (PIFS), a duration of a short interface space (SIFS), or a duration of a distributed coordination function (DCF) interframe space (DIFS).

20. The wireless communication method of claim 1, further comprising:
determining, by the first communication device, a remaining TXOP is to be returned from the second communication device to the first communication device.

21. The wireless communication method of claim 20, wherein a third field of the first frame indicates whether to return the remaining TXOP from the second communication device.

22. (canceled)

23. The wireless communication method of claim 20, wherein if a duration of an idle channel detected through a CCA is greater than or equal to a duration of a PIFS, a duration of a SIFS, a duration of a DIFS, or an indicated duration by a fourth field of the first frame, the remaining TXOP is returned from the second communication device to the first communication device.

24. (canceled)

25. The wireless communication method of claim 20, further comprising:
receiving, by the first communication device, another CF-End frame from the second communication device, wherein the another CF-End frame indicates the remaining TXOP is returned from the second communication device; or receiving, by the first communication device, a Multi-User Request-To-Send (MU-RTS) Transmission Opportunity (TXOP) Sharing (TXS) Trigger frame from the AP, wherein the MU-RTS TXS Trigger frame indicates the remaining TXOP is returned from the AP.

26. A wireless communication method, comprising:
receiving, by a second communication device, a frame from a first communication device to indicate a transmit opportunity (TXOP) sharing, wherein the frame comprises a first frame.

27-38. (canceled)

39. The wireless communication method of claim 26, wherein a first field of the first frame indicates a part time of the TXOP sharing to the second communication device.

40. (canceled)

41. The wireless communication method of claim 26, wherein in the TXOP sharing, a second field of the first frame indicates a partial bandwidth sharing of the first communication device to the second communication device.

42. (canceled)

43. The wireless communication method of claim 26, wherein in the TXOP sharing, a partial bandwidth sharing of the first communication device is used by the second communication device; or in the TXOP sharing, the partial bandwidth sharing of the first communication device and an idle channel detected by the second communication device through a clear channel assessment (CCA) are used by the second communication device.

44. The wireless communication method of claim 43, wherein a duration of idle channel detected by the second communication device through the CCA is greater than or equal to a duration of a priority interframe space (PIFS), a duration of a short interface space (SIFS), or a duration of a distributed coordination function (DCF) interframe space (DIFS).

45. The wireless communication method of claim 26, further comprising:
determining, by the second communication device, a remaining TXOP of the second communication device is to be returned to the first communication device.

46. The wireless communication method of claim 45, wherein a third field of the first frame indicates whether to return the remaining TXOP from the second communication device.

47. (canceled)

48. The wireless communication method of claim 45, wherein if a duration of an idle channel detected through a CCA is greater than or equal to a duration of a PIFS, a duration of a SIFS, a duration of a DIFS, or an indicated duration by a fourth field of the first frame, the remaining TXOP is returned from the second communication device to the first communication device.

49. (canceled)

50. The wireless communication method of claim 45, further comprising:
sending, by the second communication device, another CF-End frame to the first communication device, wherein the another CF-End frame indicates the remaining TXOP is returned from the second communication device; or sending, by the second communication device, a Multi-User Request-To-Send (MU-RTS) Transmission Opportunity (TXOP) Sharing (TXS) Trigger frame to the first communication device, wherein the second communication device comprises the AP, and the MU-RTS TXS Trigger frame indicates the remaining TXOP is returned from the AP.

51-52. (canceled)

53. A non-transitory computer readable medium, storing executable instructions that, when executed by a processor, cause the processor to perform a wireless communication method, the method comprising:
sending, by a first communication device, a frame to a second communication device to indicate a transmit opportunity (TXOP) sharing, wherein the frame comprises a first frame.
